(19) United States
(12) Patent Application Publication
(10) Pub. No.: US 2006/0047603 A1
(43) Pub. Date: Mar. 2, 2006

(54) System and method for managing digital rights

(75) Inventor: Wilhelmus Franciscus Johannes Fontijn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/531,933

(22) PCT Filed: Sep. 22, 2003
(86) PCT No.: PCT/IB03/04201

§ 371 Date: Apr. 19, 2005

(30) Foreign Application Priority Data
Oct. 22, 2002 (EP) 02079393.1

(51) Int. Cl. G06Q 99/00; H04L 9/00

(52) U.S. Cl. 705/54

(57) ABSTRACT

The present invention relates to methods and a system for managing digital rights. The invention is based on the idea that a digital voucher (100) is provided with access control information for accessing digital content located on a server (104) of a content provider. A consumer of the digital content reads the voucher (100) by means of a bar code reader, an RF detector (102) or the like. This 104 reading means (102) is connected to some computing means (103) such as a computer, a mobile phone, a PDA, a set-top box etc. The computing means (103) transfers the access control information to a server (104) of a content provider. The server (104) to which the access control information is transferred processes the access control information, and depending on the result of the processing, the computing means (103) is given different levels of access to digital content located on the server (104).

The present invention relates to a system and methods for managing digital rights.

When buying digital information or content, a common way to do it is to type a url address in your web browser, which address designates a desired Internet site, specify your credit card number and download the desired digital information. Your credit card will be charged with a given amount and you will be given access to the information you downloaded. For example, you log on to the site of a music provider. On the site, you choose a song you would like to download. The provider will ask you for your credit card number, you type the number in a field on the site, the provider will charge you $2.49 for the desired song and you get to download the chosen song to your hard disk. You now have access to the song. The digital rights associated with the song are delivered together with the actual song. The type of right associated with the song may vary. A great number of rights exist, for example “play unlimited”, “copy once”, “broadcast” etc.

This is a quick and smooth way to access digital information such as movies, books and music etc. The conventional alternative to downloading digital information in this manner is to go to a record store, book shop or video store and buy or rent a physical copy of the information, i.e. the information located on a media. Clearly, the downloading of information from the Internet is a very convenient way for a user to achieve access to digital information.

A problem associated with e-commerce and online shopping is the fact that a user typically cannot complete a transaction without specifying his or her credit card number to the content provider. Many people find it unsafe and even uncomfortable to give away their card numbers on the Internet. An alternative to specifying your credit card number is to pay as per invoice. This can be perceived as troublesome, since the transaction is not completed until the invoice has been paid. Customers sometimes tend to forget the invoice, and when it arrives, the customer has already consumed the money intended for the invoice. As a result, they do not employ e-commerce services at all, whereas going to a retail store and pay either cash or with your credit card is something people are used to and comfortable with.

When selling or lending a product such as a video cassette from a retail store, it is possible to, as in the case of e-commerce, associate different types of rights to the information product. U.S. Pat. No. 6,201,474 discloses an RFID transponder attached to a video cassette. The transponder can be programmed with data enabling authentication of the cassette, enablement/disablement of playback of the cassette, recording of the number of times the cassette has been played etc. When the cassette is inserted into an RFID equipped VCR, the VCR communicates with the transponder to, for example, check for a preprogrammed code which would disable playback of the device if present. At the time of sale, the retail store clerk could erase this code from the RFD transponder, allowing the customer to playback the cassette.

A problem associated with U.S. Pat. No. 6,201,474 is that data, e.g. digital rights, programmed into the RFID transponder is coupled to a certain content, i.e. the content of the video cassette and to a specific medium, i.e. the cassette.

An object of the present invention is to attain a system and methods by which it is possible to handle the digital rights as a product which can be associated with any copyrighted content.

Another object of the present invention is to enable smooth management of digital rights.

These objects are achieved by a system for managing digital rights according to claim 1, a method for managing digital rights according to claim 6 and a method for managing digital rights according to claim 11. Preferred embodiments are defined by the dependent claims.

According to a first aspect of the invention, a system is provided comprising a digital voucher, computing means arranged with a digital voucher reader and a server storing digital content. The digital voucher stores access control information for controlling access to digital content located on the server. The computing means is arranged with a digital voucher reader and is arranged to communicate with the digital voucher and transfer the access control information from the digital voucher to the server. The server is arranged to give the computing means access to digital content located on the server based on the result of processing of the access control information.

According to a second aspect of the invention, a method is provided in which access control information is read from a digital voucher, the access control information controlling access to digital content located on a server. The access control information stored in the digital voucher is read by means of computing means arranged with a digital voucher reader and transferred from the digital voucher to the server by means of the computing means arranged with a digital voucher reader. The computing means requires access to digital content located on the server and obtains access based on server processing of the access control information.

According to a third aspect of the invention, a method is provided in which access control information is stored in a digital voucher, the access control information controlling access to digital content located on a server. The access control information stored in the digital voucher is read by means of computing means arranged with a digital voucher reader and transferred from the digital voucher to the server by means of the computing means arranged with a digital voucher reader. The access control information is processed at the server and access to digital content located on the server is given to the computing means based on the processing of the access control information.

The invention is based on the idea that a digital voucher is bought at some retail store. The digital voucher is provided with access control information for accessing digital content located on a server of a content provider. A consumer of the digital content reads the voucher by means of a bar code reader, an RF detector or the like. This reading means is connected to some computing means such as a computer, a mobile phone, a PDA, a set-top box etc. The computing means transfers the access control information to a server of a content provider. The server to which the access control information is transferred processes the access control information, and depending on the result of the processing, the computing means is given different levels of access to digital content located on the server.

An advantage with the above given concept is that the money transaction for the purchase is performed at the retail store. There is no need for the customer to specify his/her credit card number to a content provider via the Internet. Normally, many people find it unsafe to give away their credit card number on the Internet. Neither is it necessary for the customer, as an alternative form of payment, to complete the purchase by paying a bill received some time after the actual purchase, as the voucher is paid for at the retail store.

Another advantage is that the digital rights themselves can be seen as separate products, since they are not associated with any specific copyrighted content.

Advantageously, the access control information consists of a digital right stored in a secure way in the digital voucher. This has the advantage that the digital right can be associated with any content of any provider, since the digital right can be expressed in a standard DRM (Digital Rights Management) language such as XrML, ODRL or any other type of standard DRM language that any provider has the ability to interpret and process.

Preferably, the access control information consists of an identification number. A customer order is registered at a content provider server and the server will return an identification number. The content provider server could be a server storing content owned by a specific provider, but could also be a server that combines the content from multiple content providers. The identification number, the amount of money the customer can buy content for and the type of digital right the user has to digital content on the server is now stored at the content provider server. The identification number is placed in the digital voucher and the transaction is completed. This embodiment has the advantage that a simple identification number is easy to handle compared to a digital right which must be securely stored and encrypted.

Advantageously, the digital voucher is arranged with a reference to a content provider server. The reference can advantageously be used by the computing means to find the server that the reference is designating, thereby the user does not have to write designation information such as an address manually into the computing means. The computing means arranged with a digital voucher reader is arranged to establish connection with a server by means of the reference. When the reader transfers the reference, for example a server url address, to the computing means, the computing means will establish connection with the designated server and transfer the access control information to the server. This will require a minimum of manual work from the user. The user reads the digital voucher and does not have to do anything until it is time to download the desired content. In case the access control information in advance is associated with some specific digital content, the computer means can be arranged to perform the downloading of the content as well.

Note that the digital voucher is not personal, so it can be used by anyone having access to the equipment required to read the voucher.

Further features of, and advantages with, the present invention will become apparent when studying the appended claims and the following description. Those skilled in the art realize that different features of the present invention can be combined to create embodiments other than those described in the following. Many different alterations, modifications and combinations will become apparent for those skilled in the art. The described embodiments are therefore not intended to limit the scope of the invention, as defined by the appended claims.

The description of the embodiments of the present invention will be described with reference made to the accompanying drawings, in which:

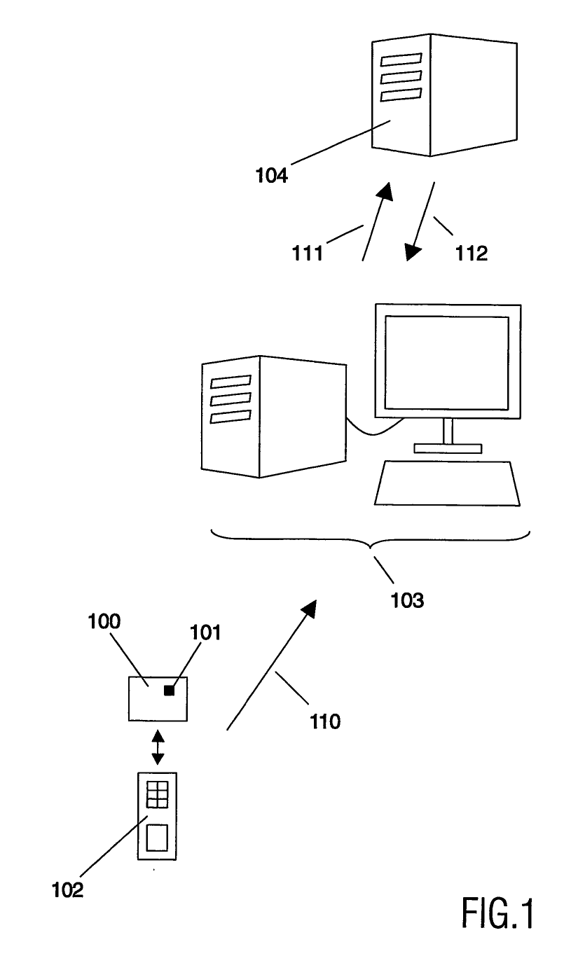

FIG. 1 shows the digital voucher concept according to an embodiment of the present invention; and

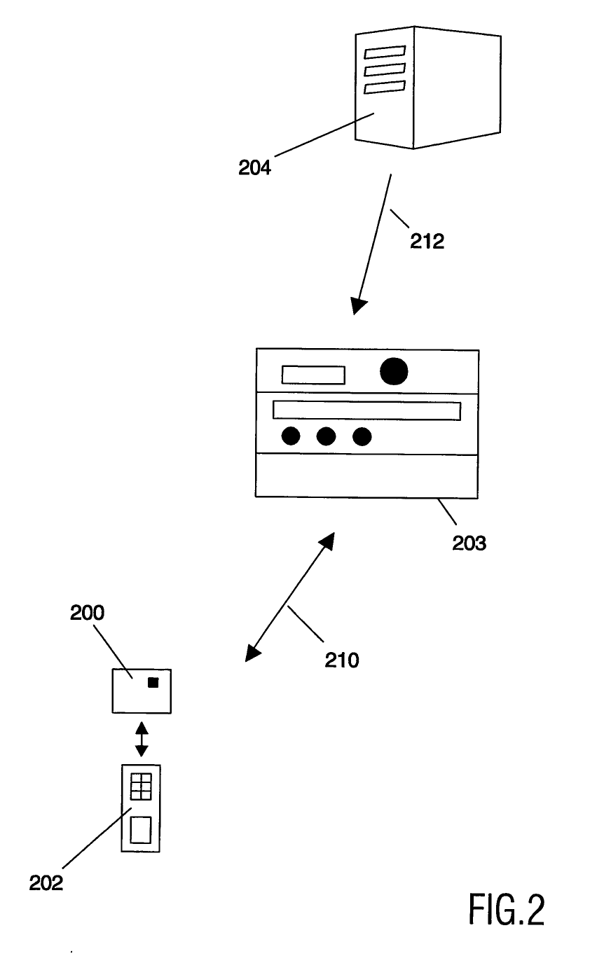

FIG. 2 shows the digital voucher concept according to another embodiment of the present invention.

In an embodiment of the digital voucher concept according to the present invention, a customer walks into a retail store and wants to buy digital content. The customer does not necessarily want to specify the actual content or even the actual content provider and the customer has the possibility to buy any type of digital right. The digital right could consist of one, or a combination, of various different types of rights such as “play unlimited”, “copy once, play never”, “burn to CD-R”, “broadcast” etc.

In this exemplifying embodiment, the customer wants to rent a movie. The customer also wants the ability to access the content an unlimited amount of times for 24 hours, which is the right a customer usually has when lending a video tape in a conventional way, i.e. bringing home a cartridge containing copyrighted material from a video shop. The digital right is thus of the type “play unlimited for 24 hours”. The customer pays for the right to the retail store assistant who stores the digital right “play unlimited for 24 hours” in a digital voucher. The digital right is preferably protected by means of encryption and the digital rights are something the retail store has “in stock”. The digital voucher is handed over to the customer. The transaction is thereby completed and the voucher is ready to be used.

FIG. 1 shows an electronic chip 101 capable of radio frequency (RF) emission embedded in a digital voucher 100. The chip 101 stores data, such as the digital right, and an RF detector 102 is used to scan the voucher 100 for the data. Data can easily be removed from or stored in the chip 101 embedded in the voucher 100. The RF detector 102 is directed against the voucher 100 and the detector 102 transmits a scan signal of a certain frequency which is received by the voucher 100, whereupon the chip 101 embedded in the voucher 100 sends a response signal to the detector 102. The response signal comprises the data stored in the voucher by the retail store assistant. The RF detector 102 communicates with a computer 103 to which the data held in the voucher 100 is transferred 110.

Since a movie can be downloaded from a great number of content providers, the user now has to provide the computer 103 with the address of the desired content provider. The content provider server 104 could be a server storing content owned by a specific provider, but could also be a server that combines the content from multiple content providers. The computer 103 transfers 111 the digital right to the content provider server 104. The server 104 receives the transferred data and processes it. The server now gives the user access to digital content. The user now downloads 112 the digital content, i.e. the movie, to the computer 103. The user will have the right to play the movie an unlimited number of times for 24 hours. When 24 hours has elapsed from the time the downloading 112 was completed, the user will no longer have access to the digital content. An alternative to downloading the movie is to let the user stream the content from the content provider server 104. Optionally, a number representing the amount of money the user has the right to access digital content for is stored in the voucher. Note that it is possible that authentication may occur between any two, or more, of the devices comprised in the present invention. This would require the voucher to be provided with some identifier or authenticator, for example in the form of an identification number or some type of encryption or digital signature. Authentication is typically used to improve the security in a system.

In an alternative embodiment of the digital voucher concept according to the present invention, the customer buys the right “play unlimited for 24 hours” for a certain movie. The retail store assistant can then store, in addition to the right, a reference to the movie at some certain content provider. When the user reads the voucher with the RF detector that is connected to the computer, the computer now has a reference in the form of e.g. the url address to the content provider server and can thereby establish a connection with the server and download the designated content without measures taken from the user. This embodiment is advantageous since it requires a minimum of manual work from the user.

In yet another alternative embodiment of the digital voucher concept according to the present invention, the customer wants to buy a digital right of the type “play unlimited” worth of [symbol] 50. The customer pays [symbol] 50 to the retail store assistant who stores the digital right and the amount in a digital voucher. The digital right and the amount is preferably protected by means of encryption. The digital voucher is handed over to the customer. The transaction is thereby completed and the voucher is ready to be used. As previously described, the user contacts any content provider by means of the RF detector and the computer. Since the user has a right of the type “play unlimited” worth of [symbol] 50, the user now can choose to download any content, such as books, movies and music, from the provider worth of [symbol] 50 and have unlimited access to the content. This embodiment is advantageous since the customer neither has to specify the actual content nor the actual content provider or even the type of content.

According to another embodiment of the digital voucher concept according to the present invention. In this exemplifying embodiment, the access control information consists of a simple identification number. As described earlier, when a customer walks into the retail store, the customer has the possibility to buy any type of digital right worth of any type of amount of money. The digital right could consist of one of, or a combination of, various different types of rights such as “play unlimlted”, “copy once, play never”, “burn to CD-R”, “broadcast” etc. Assuming that the customer buys “play unlimited” rights worth of [symbol] 10; the retail store assistant will register this order at a content provider server and the server will return an identification number to the assistant. The content provider server could be a server storing content owned by a specific provider, but could also be a server that combines the content from multiple content providers. The identification number, the type of digital right and the amount is now stored at the content provider server. The identification number is placed in the digital voucher which is handed over to the customer and the transaction is completed.

As described earlier, the data stored in the voucher is transferred to a computer by means of an RF detector. The computer transfers the identification number to the content provider server. In case the voucher contains the address of the content provider, the user does not manually have to provide the computer with this address.

The server has the attributes associated with this particular identification number, i.e. “value: [symbol] 10” and “right: play unlimited”. The user can now download, for example, a song worth of [symbol] 2.5 from the content provider server and the right to play it an unlimited number of times. The server will register the purchase and decrement the value associated with the particular identification number with [symbol] 2.5. The server now holds the attributes “value: [symbol] 7.5” and “right: play unlimited” for this identification number. When the amount of money has been spent or the time period for which the identification number is valid (e.g. one year) has elapsed, the server will deregister the identification number and the attributes associated with it. The digital voucher has thus been disabled, and the user can no longer use it. This embodiment has the advantage that the access control information consists of a simple identification number, which is very easy to handle and distribute. It also has the advantage that the amount of money associated with the digital voucher successively can be decreased, until the amount is zero.

FIG. 2 shows yet another embodiment of the digital voucher concept according to the invention. Content is downloaded 212 from a content provider server 204 (possibly via a computer not shown) to a hard disc in a sound system 203. A digital voucher 200 containing proper digital rights is bought. An RF detector 202 is connected to the sound system 203, and the downloaded content can only be played as long as the sound system 203 communicates 210 with the digital voucher 200 via the RF detector 202. This is advantageous, since the content can be moved to some other device and accessed on that device, but when the voucher 200 is not present, the content can no longer be accessed.

As clearly understood by those of ordinary skill in the art, the vendor of the digital voucher does not necessarily consist of a retail store. One could imagine vending machines to which a customer would turn to buy rights for some amount of money, whereby the vending machine will produce a digital voucher for the customer. It would also be possible for a customer to turn to a content provider, receive access control information in the form of e.g. a digital right or an identification number and store it in a voucher for further distribution. The digital content could be of any kind, such as songs downloaded via the Internet, movies via pay-per-view channels, books, software, animations, lottery tickets, online games etc. Further, the digital vouchers could take on any form, such a buttons, cards, CDs, stickers on wrapping, magazines etc.

1. A system for managing digital rights, the system comprising:
a digital voucher;
computing means arranged with a digital voucher reader; and
a server storing digital content; wherein
said digital voucher stores access control information controlling the access to the digital content located on said server;
said computing means arranged with a digital voucher reader is arranged to communicate with said digital voucher and to transfer said access control information from said digital voucher to said server; and
said server is arranged to give said computing means access to digital content located on the server based on the result of processing of said access control information.

2. The system according to claim 1, wherein the server is a specific server and the access control information comprises an identification number for accessing digital content located on the specific server.

3. The system according to claim 1, wherein the access control information comprises a digital right for accessing digital content located on any server.

4. The system according to claim 1, wherein said digital voucher is arranged with a reference to said server.

5. The system according to claim 4, wherein said computing means arranged with a digital voucher reader is arranged to establish connection with said server by means of said reference.

6. A method for managing digital rights, the method comprising the steps of:
reading access control information stored in a digital voucher by means of computing means arranged with a digital voucher reader, said access control information controlling access to digital content located on a server;
transferring said access control information from said digital voucher to said server by means of said computing means arranged with a digital voucher reader;
requiring access, by means of said computing means arranged with a digital voucher reader, to digital content located on the server and obtaining access based on server processing of the access control information.

7. The method according to claim 6, wherein the server is a specific server and the access control information comprises an identification number for accessing digital content located on the specific server.

8. The method according to claim 6, wherein the access control information comprises a digital right for accessing digital content located on any server.

9. The method according to claim 6, comprising the step of:
reading a reference to said server from said digital voucher.

10. The method according to claim 9, comprising the step of:
establishing, via said computing means arranged with a digital voucher reader, connection with said server by means of said reference.

11. A method for managing digital rights, the method comprising the steps of:
storing access control information in a digital voucher, the access control information controlling access to digital content located on a server;
reading said access control information stored in the digital voucher by means of computing means arranged with a digital voucher reader;
transferring said access control information from said digital voucher to said server by means of said computing means arranged with a digital voucher reader;
processing said access control information at said server;
giving said computing means access to digital content located on said server based on said processing of the access control information.
